(19) United States
(12) Patent Application Publication
(10) Pub. No.: US 2013/0103557 A1
(43) Pub. Date: Apr. 25, 2013

(54) METHOD AND SYSTEM FOR OPERATING A VIRTUAL ENERGY NETWORK

(71) Applicants: Audry LAROCQUE, Montreal (CA); Benoit RICHARD, Trois-Rivieres (CA)

(72) Inventors: Audry LAROCQUE, Montreal (CA); Benoit RICHARD, Trois-Rivieres (CA)

(21) Appl. No.: 13/589,025

(22) Filed: Aug. 17, 2012

Related U.S. Application Data
(60) Provisional application No. 61/524,563, filed on Aug. 17, 2011.

(51) Int. Cl. H02J 3/14; G06Q 30/04

(52) U.S. Cl. CPC H02J 3/14; G06Q 30/04
USPC 705/34; 700/295

(57) ABSTRACT

The present relates to a method and system for operating a virtual energy network. The method and system receives electricity at a local energy network from an electric grid, stores at an energy storage appliance electricity received from the electric grid at a first period of time, and provides electricity from the energy storage appliance to the local energy network at a second period of time. The cost of the electricity provided by the electric grid is lower at the first period of time than at the second period of time. The energy storage appliance is connected to a management unit via a communication network, from which it receives an energy storage policy. Also, the electric grid, a plurality of energy storage appliances connected to the electric grid and to a corresponding plurality of local energy networks, and the management unit constitute a virtual energy network.

### TECHNICAL FIELD

The present disclosure relates to the field of electrical energy consumption management; and more particularly to an infrastructure for optimizing the electrical energy consumption of households.

### BACKGROUND

Distributors of electricity are facing an increasing demand for electricity, both in so-called developing countries where the needs are catching up with those of previously industrialized countries, and in developed countries where new usages are increasing the demand for electricity.

In particular, the demand for electricity for the residential market is increasing. This is due in part to the proliferation of a variety of home devices, enabling communications, Internet connectivity, multimedia and entertainment activities, etc. For example, the presence of television sets and computers in a household is not new. However, there is a growing tendency to have several television sets for a single family, and to have one (and even several) computer for each member of the family.

Although the electric consumption of these home devices is not high taken individually, the addition of several new home devices for each household puts a significant pressure on the electricity grid (the electricity grid includes both the electricity production infrastructures and the electricity distribution networks) of local or national electricity providers. And the future development of electric cars may also have a significant impact, regarding the electricity needs of the households who will own an electric car.

A significant issue for an electricity provider is that it shall be able to sustain a pick of electricity demand. This peak may be relatively short in terms of duration, but the electricity grid of the electricity provider shall be dimensioned to support this peak. Outside the peak period, the demand for electricity is lower, but the infrastructure to support the peak of electricity demand is still present (the infrastructure is over-provisioned for the periods of time outside the peak of electricity consumption). Thus, there is a significant economical cost for an electricity provider, to deploy an infrastructure dimensioned to support a peak of electricity demand.

Since the peak of electricity demand usually occurs at the same period(s) of time within a day, electricity providers are encouraging consumers to decrease their electricity consumption during the period(s) of peak electricity demand, and to increase their electricity consumption outside the period(s) of peak electricity demand. The incentive is usually based on the price: the electricity is more expensive during the peak period(s) and less expensive outside the peak period(s). The deployment of smart meters in the households is a way to implement smart billing policies, to modulate the price of electricity based on time.

However, these smart billing policies are not convenient for the end users. These end users have to adapt their electricity consumption patterns, in order to control their electricity bills. But it is not very practical for an end user, to delay an activity consuming electricity, in order to avoid a peak period (and the associated increased cost of electricity consumption during this peak period).

Therefore, there is a need for overcoming the above discussed limitations, concerning the lack of availability of a mechanism for the end users to adapt to the smart billing policies implemented by electricity distributors (for the purpose of better managing the peaks in electricity demand). An object of the present is therefore to provide a method and system for operating a virtual energy network.

### SUMMARY

According to a first aspect, the present disclosure provides a method for operating a virtual energy network. For doing so, the method receives electricity at a local energy network from an electric grid. The method stores at an energy storage appliance electricity received from the electric grid at a first period of time. And the method provides electricity from the energy storage appliance to the local energy network at a second period of time. Further, the cost of the electricity provided by the electric grid is lower at the first period of time than at the second period of time.

According to a second aspect, the present disclosure provides a system for operating a virtual energy network. For doing so, the system comprises a local energy network for receiving electricity from an electric grid, and receiving electricity from an energy storage appliance. The system also comprises the energy storage appliance for storing electricity received from the electric grid at a first period of time, and providing electricity to the local energy network at a second period of time. Further, the cost of the electricity provided by the electric grid is lower at the first period of time than at the second period of time.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a system for operating a virtual energy network, according to a non-restrictive illustrative embodiment;

FIG. 2 illustrates a method for operating a virtual energy network, according to a non-restrictive illustrative embodiment;

FIG. 3 illustrates an energy storage appliance, according to a non-restrictive illustrative embodiment.

### DETAILED DESCRIPTION

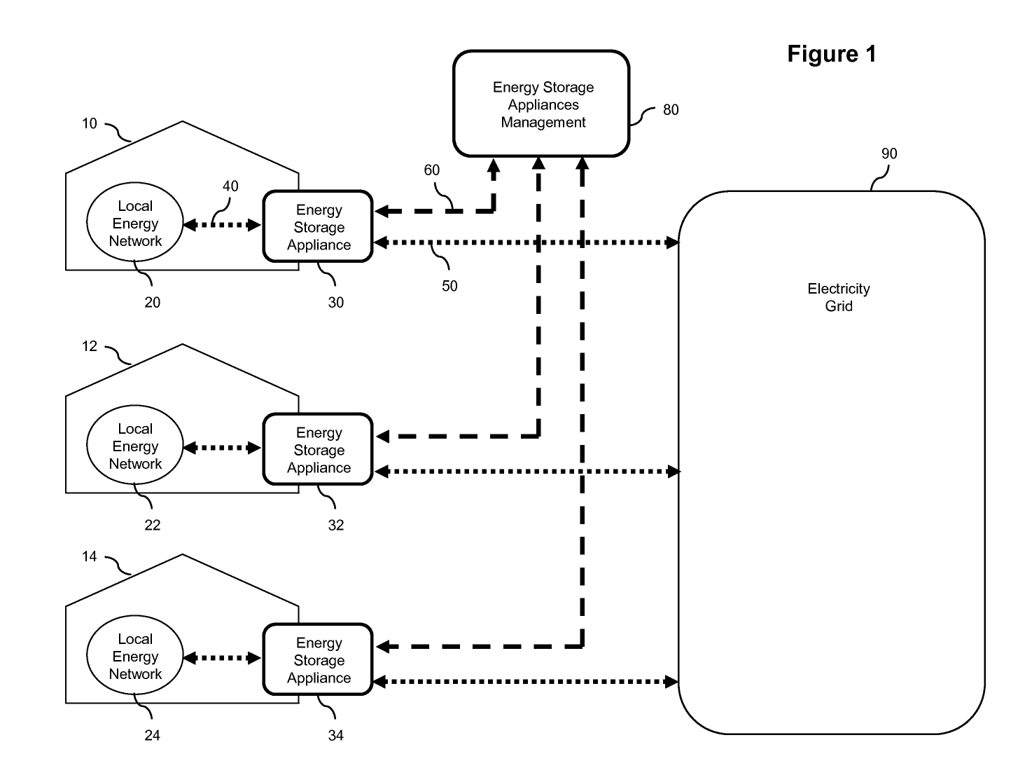

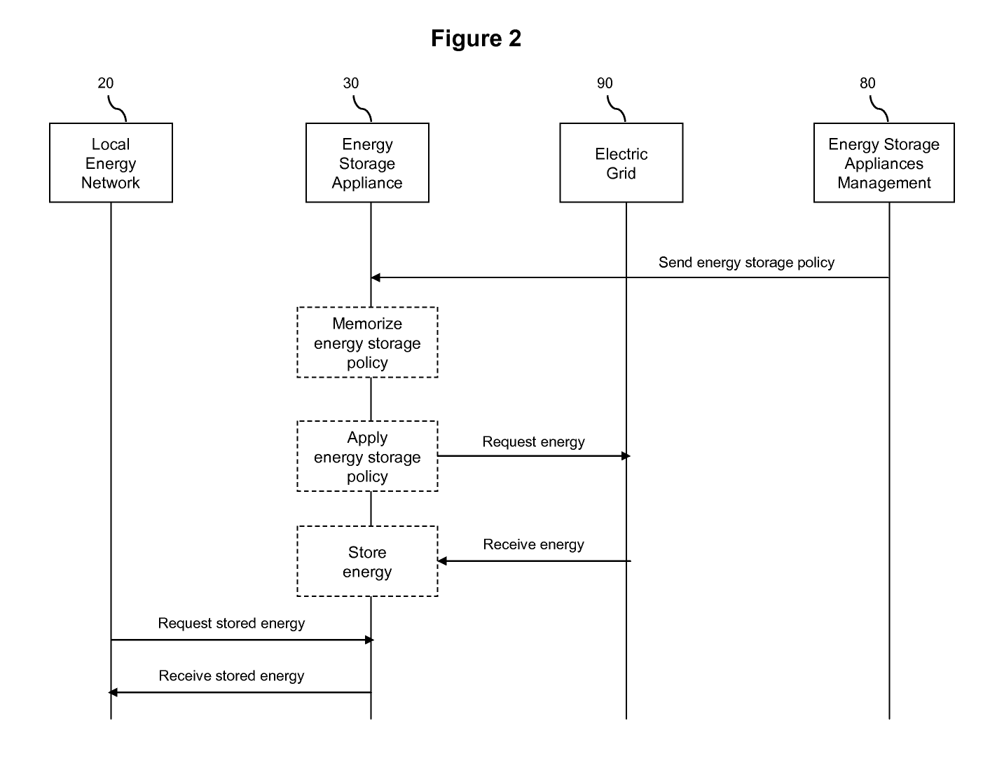

Now referring concurrently to FIGS. 1 and 2, a method and system for operating a virtual energy network will be described.

A virtual energy network is represented in FIG. 1. It includes local energy networks 20, 22, and 24; each local energy network providing the energy used to operate a building (respectively 10, 12, and 14). The notion of building is taken in a broad sense, including a house, an individual apartment in a larger building, a building for commercial or professional purposes, etc. In a preferred embodiment, the local energy network is an electric network, providing the electricity required to operate the electric appliances in the building, and additionally to heat/cool the building when appropriate.

The virtual energy network also includes an electricity grid 90. The electricity grid is operated by an electricity distributor, and includes both the electricity production infrastructures (e.g. nuclear power plants, gas or coal power plants, etc) and the electricity distribution networks (not represented in FIG. 1). The electricity grid covers a given geographical area, for example an entire country, several countries, or a region in a country. In some cases, the production of electricity is operated by a first entity (e.g. a company owning nuclear power plants), and the distribution of electricity is operated by a second entity (e.g. a company owning a private electricity distribution network). In these cases, the electricity grid 90 represents the conjunction of the electricity production infrastructures of the first entity, and the electricity distribution network of the second entity.

In a traditional operational mode, the local energy networks 20, 22, and 24 of the buildings 10, 12, and 14 are directly connected to the electricity grid 90. The electricity grid 90 provides the electricity required to operate the local energy networks 20, 22, and 24 of the buildings 10, 12, and 14. Although a single electricity grid 90 is represented in FIG. 1, several electricity grids may be available in a specific region or country. In this case, each electricity grid is operated by a specific electricity distributor, and each owner of a building 10, 12, and 14 selects an electricity distributor. Then, the local energy network 20, 22, and 24 of the respective building is connected to the electricity grid 90 of the selected electricity distributor. A specific local energy network 20, 22, and 24 may be connected to several electricity grids 90 (for operational and economical reasons).

Additionally, in the traditional mode, smart meters (not represented in FIG. 1) may be deployed in some of the buildings 10, 12, and 14. One role of the smart meters is to apply specific billing policies: each day is split into two or more periods of time. And the electricity consumed by a local energy network 20, 22, and 24 during a specific period of time is billed at a specific price fixed for this specific period of time. For example, the electricity consumed between 6 am and 10 pm is billed at 8 cents per kilowatt, while the electricity consumed between 10 pm and 6 am is billed at 3 cents per kilowatt. Specific billing policies may also be applied based on the day in a week (e.g. work days versus week ends), or the month in a year (e.g. summer versus winter). One objective of applying smart billing policies via a smart meter is to influence the electricity consumption patterns of the customers, in order for example to reduce the consumption of electricity during the peak hours.

The virtual energy network includes energy storage appliances 30, 32, and 34. An energy storage appliance (e.g. 30) is deployed in/close to a building (e.g. 10). An energy storage appliance 30 is connected 50 to the electricity grid 90. Via this connection 50, the energy storage appliance uses the electricity available via the electricity grid 90 to make a reserve of energy, at a specific period of time when the cost of electricity is lower (as defined by the aforementioned billing policies applied by smart meters). The energy received from the electricity grid 90 is stored by the energy storage appliance 30, for example by means of batteries.

An energy storage appliance (e.g. 30) is connected 40 to the local energy network (e.g. 20) of the building (e.g. 10) to which the energy storage appliance is related. Via this connection 40, the energy storage appliance (e.g. 30) acts as a source of energy for the local energy network (e.g. 20). The energy storage appliance (e.g. 30) provides the energy to the local energy network (e.g. 20) at a specific period of time when the cost of electricity is higher if consumed from the electric grid 90 (as defined by the aforementioned billing policies applied by smart meters).

The energy provided by the energy storage appliances 30, 32, and 34 is billed by the company deploying these energy storage appliances 30, 32, and 34. A smart billing policy is applied in this case too, by the company deploying the energy storage appliances. The price is determined to make it interesting for a customer to deploy an energy storage appliance. Basically, the virtual energy network Operator which deploys the energy storage appliances 30, 32, and 34 buys energy from the electricity grid 90 at an off-peak rate, stores it in the energy storage appliances, and resells it to the local energy networks 20, 22, and 24 during peak hours, at a tariff between the off-peak rate and the peak rate.

Although not represented in FIG. 1 (for simplification purposes), the local energy networks 20, 22, and 24 are also directly connected to the electricity grid 90. Thus a local energy network (e.g. 20) has the capacity to use energy provided by either the electricity grid 90, or the energy storage appliance (e.g. 30), at any time. The only constraint for using energy from the energy storage appliance is to have some energy stored in it.

The virtual energy network also includes an energy storage appliances management unit 80. A management unit 80 is connected to a group of energy storage appliances 30, 32, and 34 via a communication network (not represented in FIG. 1). Such a communication network may consist, for example, of a cellular network. The management unit 80 manages the energy storage appliances 30, 32, and 34 under its control. The management consists in sending energy storage policies to the energy storage appliances. An energy storage policy defines at which periods of time energy shall be requested from the electricity grid 90 and stored in an energy storage appliance (e.g. 30). An energy storage policy also defines at which periods of time energy stored in an energy storage appliance (e.g. 30) may be requested by a local energy network (e.g. 20) from the corresponding energy storage appliance. The objective of the energy storage policies is to enforce the smart billing policies defined by the company (the virtual energy network Operator) deploying the energy storage appliances. Basically, it consists in buying energy from the electricity grid 90 when it is cheaper, storing it in the energy storage appliances 30, 32, and 34, and providing the stored energy to the local energy networks 20, 22, and 24 when the energy from the electric grid 90 is more expensive.

Additionally, the management unit 80 is in charge of performing the billing of the energy provided via the energy storage appliances 30, 32, and 34 to the local energy networks 20, 22, and 24 respectively. For this purpose, the energy storage appliances (e.g. 30) report to the management unit 80 all the necessary information. For example, the quantity of energy received from the electricity grid 90 and the time of occurrence; and the quantity of energy provided to the local energy networks (e.g. 20), and the time of occurrence.

Also, operational parameters relative to each energy storage appliances 30, 32, and 34 are reported to the management unit 80 on a regular basis, to ensure that each energy storage appliance 30, 32, and 34 operates properly.

Furthermore, parameters related to the behaviors of the owners of the buildings (e.g. 10) regarding their energy consumption, as well as parameters related to the energy consumption patterns of specific appliances connected to the local energy networks (e.g. 20) may be reported to the management unit 80, if the energy storage appliances (e.g. 30) have the capability to collect these parameters. The management unit 80 may use these parameters to perform a Business Intelligence analysis related to the energy consumption patterns of the owners of the buildings 10, 12, and 14.

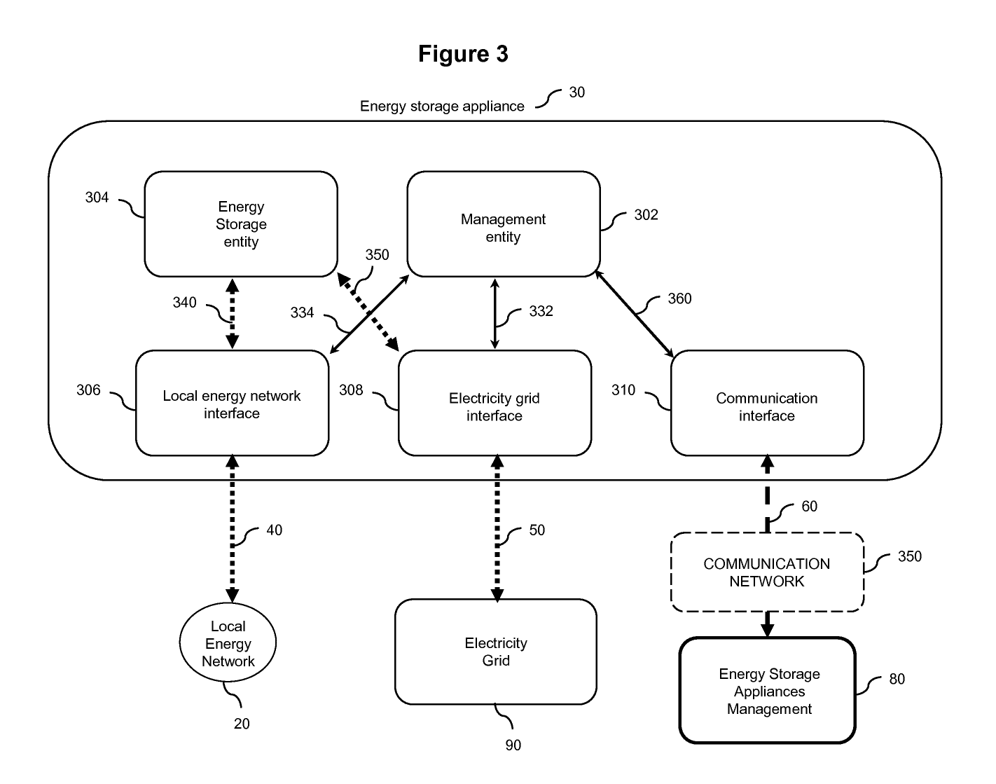

Now referring to FIG. 3, an energy storage appliance will be described.

An energy storage appliance 30 includes a communication interface 310, to communicate with an energy storage appliances management unit 80, via a communication network 350.

An energy storage appliance 30 includes an electricity grid interface 308, to request/receive 50 energy from an electricity grid 90.

An energy storage appliance 30 includes a local energy network interface 306, to receive requests for/provide 40 energy to a local energy network 20.

An energy storage appliance 30 includes an energy storage entity (e.g. one or several batteries) 304. The energy storage entity 304 interacts 350 with the electricity grid interface 308, to receive and store energy provided by the electricity grid 90. The energy storage entity 304 interacts 340 with the local energy network interface 306 to provide the energy stored in the energy storage entity 304 to the local energy network 20.

An energy storage appliance 30 includes a management entity 302. The management entity 302 interacts 360 with the communication interface 310, to exchange information with the energy storage appliances management 80. Information collected by the management entity 302 may be stored locally for a specific amount of time, before transmission to the energy storage appliances management unit 80. In the same manner, information received from to the energy storage appliances management unit 80 is stored locally at the management entity 302 (e.g. the aforementioned energy storage policies).

The management entity 302 interacts 332 with the electricity grid interface 308 and interacts 334 with the local energy network interface 306. These interactions include the enforcement of the energy storage policies stored in the management entity 302, determining when energy shall be received from the electricity grid 90 and stored in the energy storage entity 304; and determining when energy stored in the energy storage entity 304 shall be provided to the local energy network 20.

Although the present disclosure has been described in the foregoing description by way of illustrative embodiments thereof, these embodiments can be modified at will, within the scope of the appended claims without departing from the spirit and nature of the appended claims.

What is claimed is:

1. A method for operating a virtual energy network, the method comprising:
receiving electricity at a local energy network from an electric grid;
storing at an energy storage appliance electricity received from the electric grid at a first period of time; and
providing electricity from the energy storage appliance to the local energy network at a second period of time;
wherein the cost of the electricity provided by the electric grid is lower at the first period of time than at the second period of time.

2. The method of claim 1, wherein the energy storage appliance comprises at least one battery for storing the electricity received from the electric grid.

3. The method of claim 1, wherein the energy storage appliance is connected to a management unit via a communication network.

4. The method of claim 3, wherein the energy storage appliance receives an energy storage policy from the management unit.

5. The method of claim 4, wherein the energy storage policy specifies at least one period of time for storing electricity received from the electric grid in the energy storage appliance and at least one period of time for providing the electricity stored in the energy storage appliance to the local energy network.

6. The method of claim 5, wherein the at least one period of time for storing the electricity and the at least one period of time for providing the electricity are determined based on the price of the electricity provided by the electric grid at different periods of time.

7. The method of claim 3, wherein the electric grid, a plurality of energy storage appliances connected to the electric grid and to a corresponding plurality of local energy networks, and the management unit constitute a virtual energy network;
wherein the operations of the plurality of energy storage appliances are controlled by the management unit.

8. The method of claim 3, wherein the energy storage appliance sends a report to the management unit comprising:
a first quantity of electricity received from the electric grid and stored in the energy storage appliance, and a corresponding first time of occurrence; and
a second quantity of electricity provided by the storage energy appliance to the local energy network, and a corresponding second time of occurrence.

9. The method of claim 8, wherein the management unit calculates a bill taking into consideration the first quantity of electricity, the price of electricity when provided by the electric grid at the first time of occurrence, the second quantity of electricity, and the price of electricity when provided by the electric grid at the second time of occurrence.

10. The method of claim 1, wherein the local energy network provides energy used to operate a building; wherein a building comprises one of: a house, an individual apartment in a larger building, a building for commercial or professional purposes.

11. A system for operating a virtual energy network, the system comprising:
a local energy network for:
receiving electricity from an electric grid, and
receiving electricity from an energy storage appliance; and
the energy storage appliance for:
storing electricity received from the electric grid at a first period of time, and
providing electricity to the local energy network at a second period of time;
wherein the cost of the electricity provided by the electric grid is lower at the first period of time than at the second period of time.

12. The system of claim 11, wherein the energy storage appliance comprises at least one battery for storing the electricity received from the electric grid.

13. The system of claim 11, wherein the energy storage appliance is connected to a management unit via a communication network.

14. The system of claim 13, wherein the energy storage appliance receives an energy storage policy from the management unit.

15. The system of claim 14, wherein the energy storage policy specifies at least one period of time for storing electricity received from the electric grid in the energy storage appliance and at least one period of time for providing the electricity stored in the energy storage appliance to the local energy network.

16. The system of claim 15, wherein the at least one period of time for storing the electricity and the at least one period of time for providing the electricity are determined based on the price of the electricity provided by the electric grid at different periods of time.

17. The system of claim 13, wherein the electric grid, a plurality of energy storage appliances connected to the electric grid and to a corresponding plurality of local energy networks, and the management unit constitute a virtual energy network; wherein the operations of the plurality of energy storage appliances are controlled by the management unit.

18. The system of claim 13, wherein the energy storage appliance sends a report to the management unit comprising:
a first quantity of electricity received from the electric grid and stored in the energy storage appliance, and a corresponding first time of occurrence; and
a second quantity of electricity provided by the storage energy appliance to the local energy network, and a corresponding second time of occurrence.

19. The system of claim 18, wherein the management unit calculates a bill taking into consideration the first quantity of electricity, the price of electricity when provided by the electric grid at the first time of occurrence, the second quantity of electricity, and the price of electricity when provided by the electric grid at the second time of occurrence.

20. The system of claim 11, wherein the local energy network provides energy used to operate a building; wherein a building comprises one of: a house, an individual apartment in a larger building, a building for commercial or professional purposes.
